(19) United States
(12) Patent Application Publication
(10) Pub. No.: US 2015/0132727 A1
(43) Pub. Date: May 14, 2015

(54) Set of Blocks and Method For Teaching Mathematics

(71) Applicants: Dennis Glenn Collins, Winamac, IN (US); Glenn Hamilton Collins, Columbus, OH (US)

(72) Inventors: Dennis Glenn Collins, Winamac, IN (US); Glenn Hamilton Collins, Columbus, OH (US)

(21) Appl. No.: 14/521,046

(22) Filed: Oct. 22, 2014

Related U.S. Application Data
(60) Provisional application No. 61/962,507, filed on Nov. 9, 2013.

(51) Int. Cl. G09B 19/02

(52) U.S. Cl. CPC G09B 19/02
USPC 434/205

(57) ABSTRACT

A set of education blocks and method for teaching mathematics through equation checking includes a plurality of polygonal-shaped numeral blocks each having a plurality of faces, wherein a top face includes a numeral and a bottom face opposite the top face includes a dot pattern corresponding to the numeral on the top face. The set of blocks includes a plurality of polygonal-shaped operator blocks each including a plurality of faces, a top face presenting an arithmetic operation symbol. Selected numeral and operator blocks are selectively arranged to form an equation, an inversion of the numeral blocks revealing respective dot patterns to confirm the equation's correctness. The method of teaching mathematics includes each numeral block associating a numeral with its corresponding dot pattern representation, textual representation in one or more languages, and a color indicia indicative of the numeral being even, odd, or prime.

### REFERENCE TO RELATED APPLICATIONS

This application claims the benefit of provisional patent application U.S. Ser. No. 61/962,507 filed Nov. 9, 2013 titled Collins Math Magic Natural Number Blocks, the provisional patent application being incorporated by reference in full herein.

### BACKGROUND OF THE INVENTION

This invention relates generally to educational toys and, more particularly, to a set of numeral and operator blocks and a method of using the blocks to teach math concepts and for equation checking.

Educational themes are often incorporated into toys in order to increase the interest of children to participate in a learning experience. In other words, an educational goal is more likely to be experienced so long as the child is somewhat entertained. Blocks are often utilized to introduce children to letters of the alphabet so as to encourage letter recognition or, later on, to encourage spelling or reading.

There is also a need to interest children in numbers and to basic arithmetic. However, numbers and math concepts have largely been absent from educational block sets. Or, numerals on blocks are rarely if ever associated with a number of items described by the numeral. For example, the number “3” on a block is not associated with 3 items (such as 3 dots, 3 coins, 3 pencils, etc) even though the use of “manipulatives” will later be used in math curriculums to teach such an association. In fact, current sets of number blocks have almost no features of arithmetic, such as blocks with math operation symbols such that equations can be arranged, indications that a number is odd, even, or prime, or with associations between a numeral and a dot pattern demonstrating an equal number of items.

Therefore, it would be advantageous to have a set of educational blocks having a plurality of numeral blocks each having a natural number and a dot patterns indicative of the number of items represented by the natural number. Further, it would be advantageous to have a set of educational blocks having other features that teach other elements of mathematics and number properties. In addition, it would be advantageous to have a set of educational blocks having a plurality of operator blocks so that numerals and operators can be arranged in equations and then the equations can be checked by revealing associated dot patterns.

### SUMMARY OF THE INVENTION

A set of education blocks and method for teaching mathematics through equation checking according to the present invention includes a plurality of polygonal-shaped numeral blocks each having a plurality of faces, wherein a top face includes a numeral and a bottom face opposite the top face includes a dot pattern corresponding to the numeral on the top face. The set of blocks includes a plurality of polygonal-shaped operator blocks each including a plurality of faces, a top face presenting an arithmetic operation symbol. Selected numeral and operator blocks are selectively arranged to form an equation, an inversion of the numeral blocks revealing respective dot patterns to confirm the equation's correctness. The method of teaching mathematics includes each numeral block associating a numeral with its corresponding dot pattern representation, textual representation in one or more languages, and a color indicia indicative of the numeral being even, odd, or prime. Learning arithmetic is enhanced when a student sees an equation in numerals, text, and with other visual cues.

Therefore, a general object of this invention is to provide a set of educational blocks each of which includes a numeral and a dot pattern indicative of the number of items represented by the numeral.

Another object of this invention is to provide a set of educational blocks, as aforesaid, in which each numeral block includes other features associated with the numeral on the block, such as if the numeral is even, odd, or prime.

Still another object of this invention is to provide a set of educational blocks, as aforesaid, in which the numeral on a respective block is also represented in two different languages.

Yet another object of this invention is to provide a method of teaching arithmetic in which numeral and operator blocks may be arranged into an equation and then checked by revealing respective dot patterns of each numeral block and counting them.

A further object of this invention is to provide a set of blocks in which each block has a polygonal configuration that is easy to manipulate, arrange, or stack.

A still further object of this invention is to provide a set of educational blocks having numerals from 0 up through 20 or higher so that single digit numerals arranged in an equation can have closure, i.e. the result of the arithmetic operation.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a front perspective view of a numeral block associated with the numeral “1.”

FIG. 1b is a rear perspective view of a numeral block associated with the numeral “1.”

FIG. 1c is an inverted perspective view as in FIG. 1a;

FIG. 1d is an inverted perspective view as in FIG. 1b;

FIG. 2a is a front perspective view of a numeral block associated with the numeral “2.”

FIG. 2b is a rear perspective view of a numeral block associated with the numeral “2”;

FIG. 2c is an inverted perspective view as in FIG. 2a;

FIG. 2d is an inverted perspective view as in FIG. 2b;

FIG. 3a is a front perspective view of a numeral block associated with the numeral “3”;

FIG. 3b is a rear perspective view of a numeral block associated with the numeral “3”;

FIG. 3c is an inverted perspective view as in FIG. 3a;

FIG. 3d is an inverted perspective view as in FIG. 3b;

FIG. 4a is a front perspective view of a numeral block associated with the numeral “4”;

FIG. 4b is a rear perspective view of a numeral block associated with the numeral “4”;

FIG. 4c is an inverted perspective view as in FIG. 4a;

FIG. 4d is an inverted perspective view as in FIG. 4b;

FIG. 5a is a front perspective view of a numeral block associated with the numeral “5”;

FIG. 5b is a rear perspective view of a numeral block associated with the numeral “5”;

FIG. 5c is an inverted perspective view as in FIG. 5a;

FIG. 5d is an inverted perspective view as in FIG. 5b;

FIG. 6a is a front perspective view of an operator block associated with the operator “+”;

FIG. 6b is a rear perspective view of an operator block associated with the operator “+”;

FIG. 7a is a front perspective view of an operator block associated with the operator “−”;

FIG. 7b is a rear perspective view of an operator block associated with the operator “−”;

FIG. 8a is a front perspective view of an operator block associated with the operator “X”;

FIG. 8b is a rear perspective view of an operator block associated with the operator “X”;

FIG. 9a is a front perspective view of an operator block associated with the operator “÷”;

FIG. 9b is a rear perspective view of an operator block associated with the operator “÷”;

FIG. 10a is a front perspective view of an operator block associated with the operator “=”;

FIG. 10b is a rear perspective view of an operator block associated with the operator “=”;

FIG. 11 is a front perspective view of an operator block associated with the operator “0”;

FIG. 12 is a front perspective view of respective numeral and operator blocks arranged in an equation;

FIG. 13 is an inverted perspective view of the equation arranged in FIG. 12;

FIG. 14 is a front perspective of the equation arranged in FIG. 12 with each block rotated one quarter turn;

FIG. 15 is a rear perspective view of the equation as in FIG. 14;

FIG. 16a is a perspective view of double numeral blocks and operator blocks arranged in an equation;

FIG. 16b is a perspective view of the equation arrangement as in FIG. 16a with all blocks pivoted forward one quarter turn; and

FIG. 17 is a perspective view of a set of numeral blocks arranged to form a magic square.

### DESCRIPTION OF THE PREFERRED EMBODIMENT

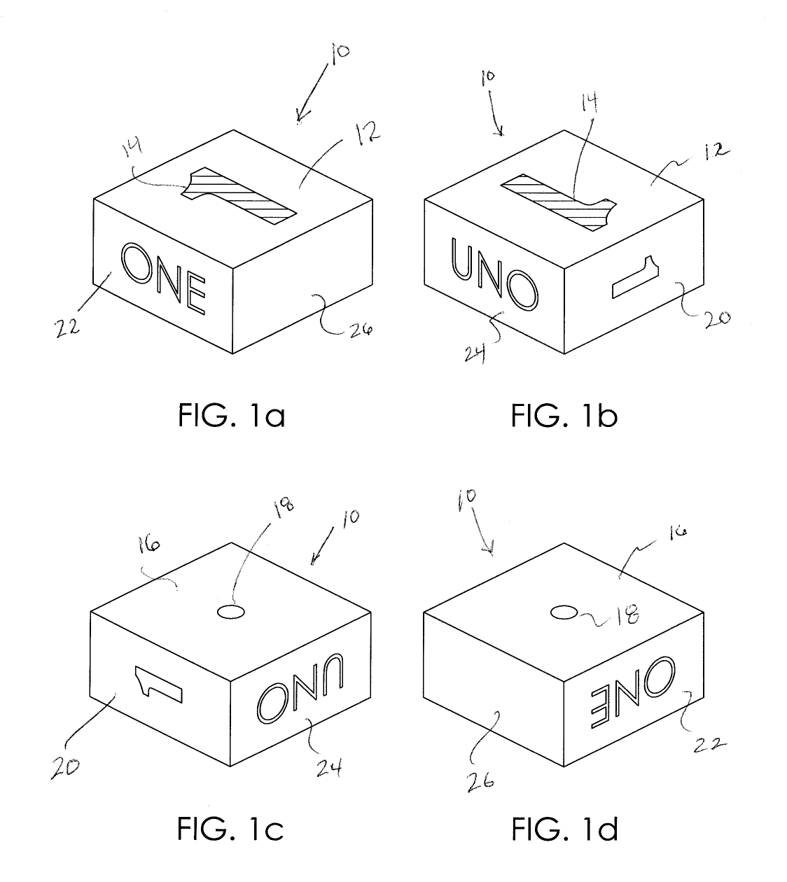

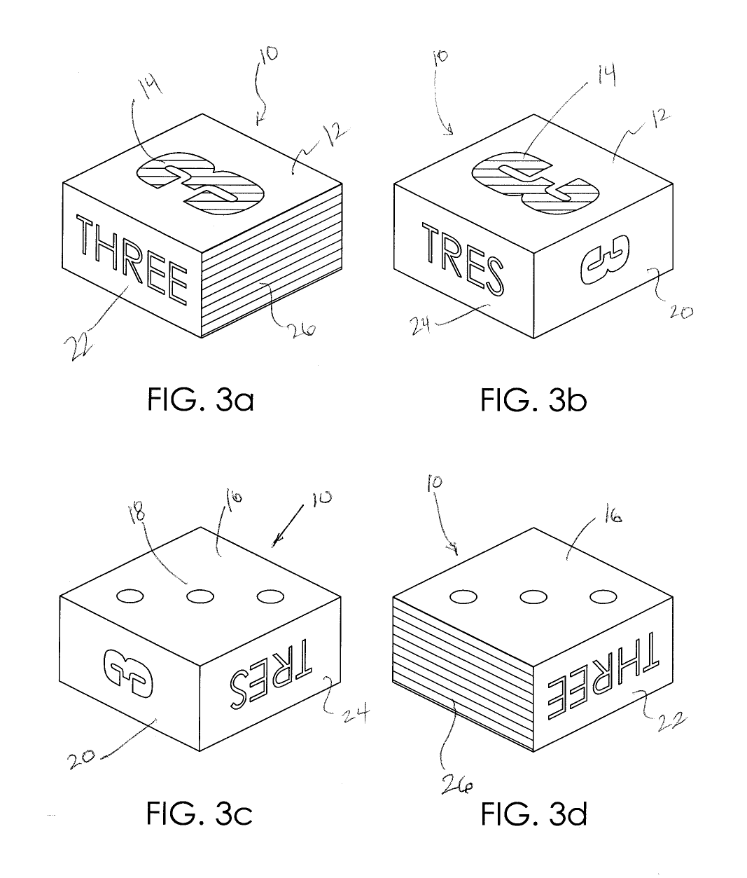

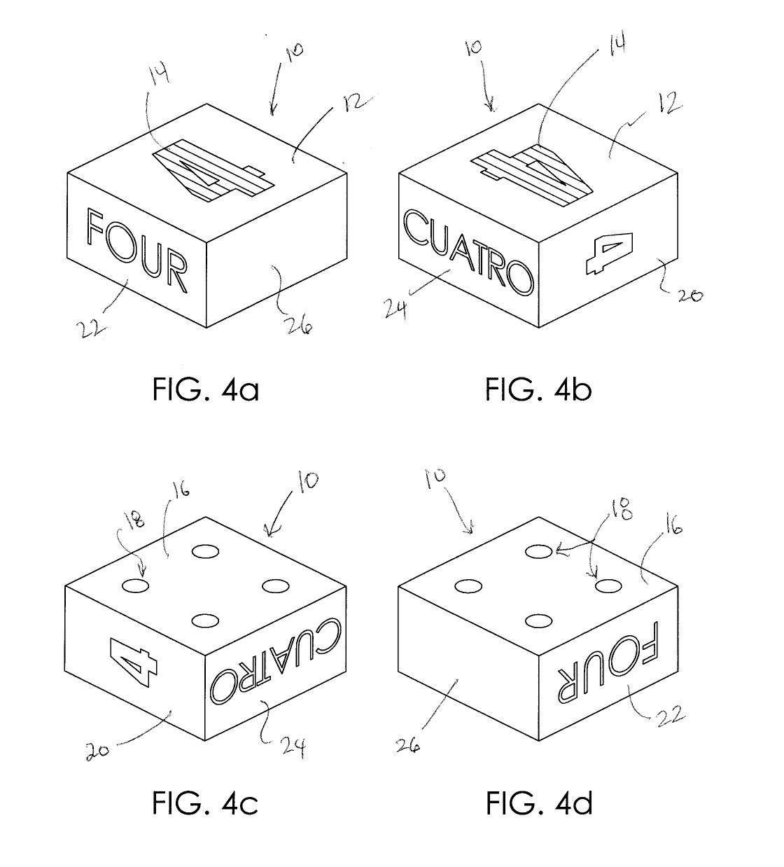

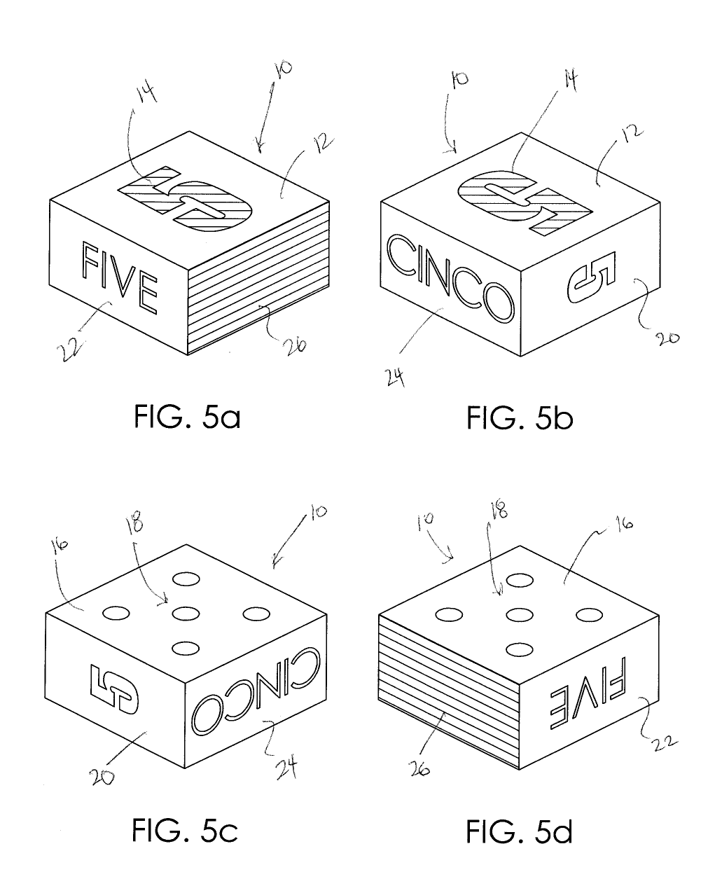

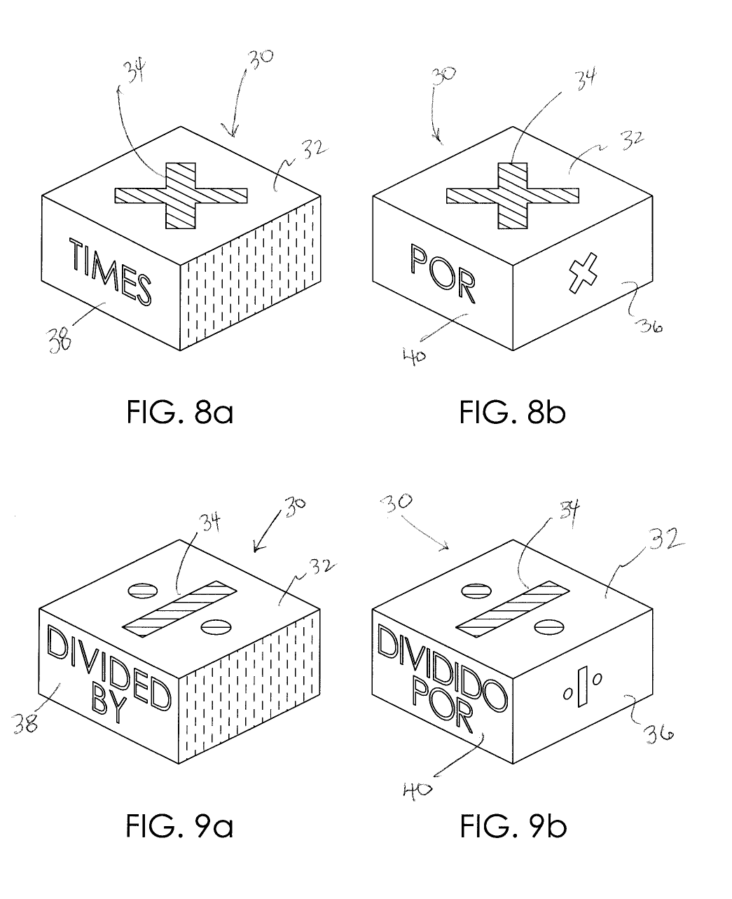

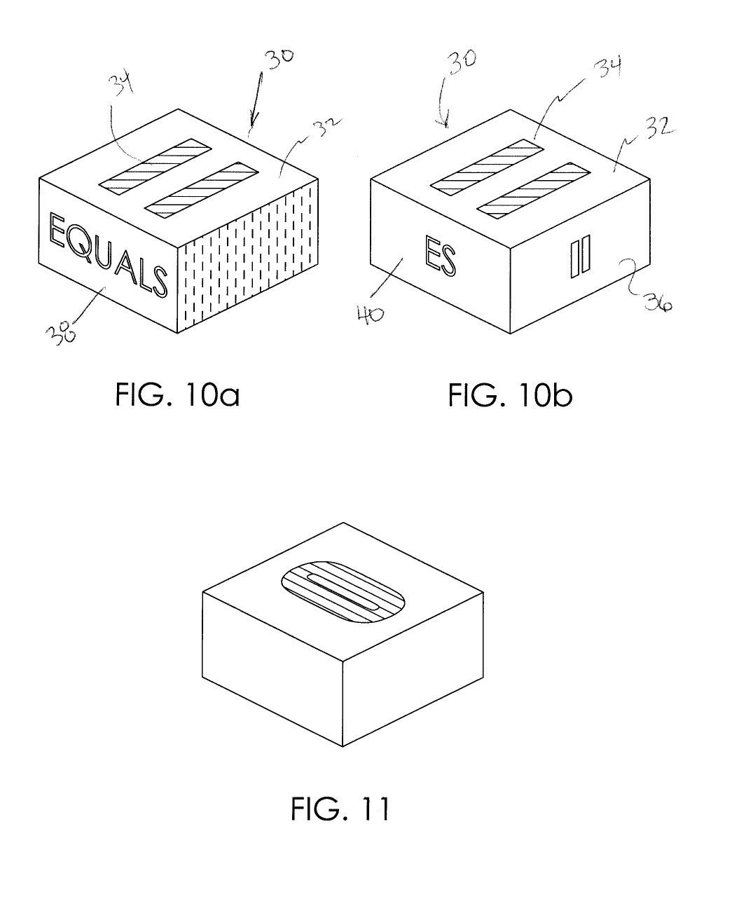

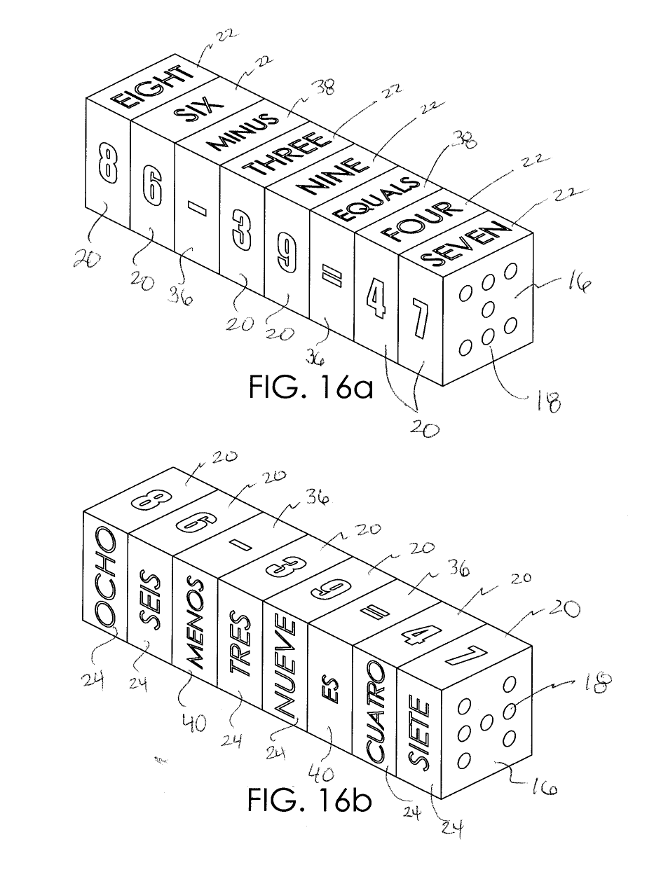

A set of education blocks and method for using the same to teach arithmetic through equation checking properties and association according to a preferred embodiment of the present invention will now be described with reference to FIGS. 1 to 17 of the accompanying drawings. The set of education blocks includes a plurality of numeral blocks 10 and a plurality of operator blocks 30 that may be arranged to form equations and include features characteristics that enhance learning.

In an embodiment, each numeral block 10 has a polygonal configuration having a plurality of faces, each face having a generally planar configuration and being situated at right angles to adjacent faces. In other words, each numeral block 10 may be in the form of a truncated “half-cube” tile and may have dimensions of about 1.5 in.×1.5 in.×0.75 in. although other configurations would also work. Each numeral block 10 may be constructed of wood or plastic.

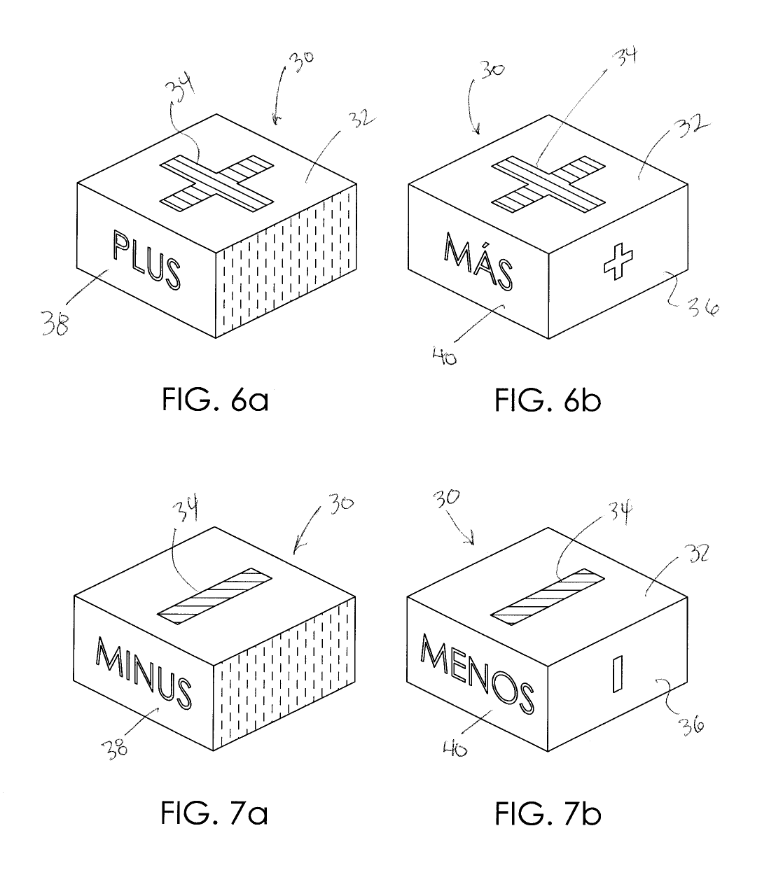

Each numeral block 10 may have a top face 12 presenting a numeral 14 thereon and an opposed bottom face 16 presenting a dot pattern 18 corresponding to the value of the numeral 14. The numeral 14 and dot pattern 18 and any other symbols may be applied with ink, stickers, paint, wood-burning, or actually engraved into the surface of the respective face of the numeral block 10. For instance, the top face 12 of one exemplary numeral block 10 may show a “3” and a corresponding bottom face 16 may show a dot pattern 18 having 3 dots. In another exemplary numeral block 10, a top face 12 may present a “5” and a corresponding bottom face 16 may show a dot pattern 18 having five dots. In general, the dot pattern 18 on any bottom face 16 of a numeral block 10 corresponds to an associated numeral 14 that represents an equivalent quantity. A numeral block 10 having a top face 12 facing upwardly may be inverted by a student to calculate or confirm an equation by counting the dots of a dot pattern 18 on a corresponding bottom face 16, as will be described in more detail later. In an embodiment, the numeral blocks 10 may include single digit numerals, double digit numerals, or the single digit numeral blocks may be combined together to represent double digit numerals (FIG. 6a).

Each operator block 30 may have a top face 32 presenting an arithmetic operation symbol 34, such as an addition sign (plus), a subtraction sign (minus), a multiplication sign (times), a division sign (divided by), or the like. Other operation symbols that may be included on an operator block 30 include an equals sign (=), inequality (< or >), gozinta (indicative of a factor relationship), and an algebraic variable.

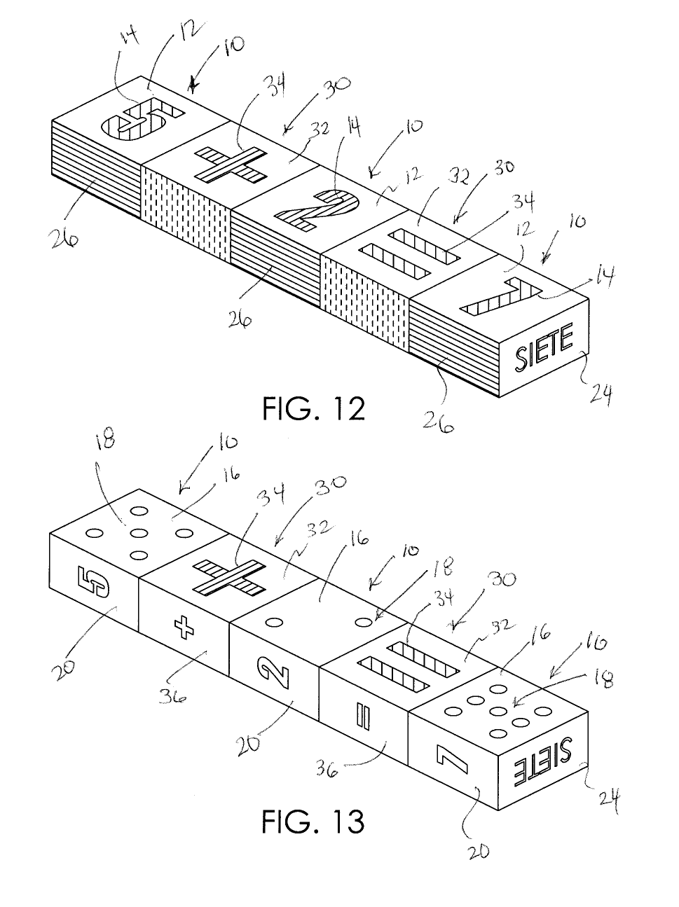

It can be seen that two or more numeral blocks 10 may be selected and one or more operator blocks 30 may be selected and, together arranged to form an equation. For example, a “2” and a “3” numeral block may be arranged, such as on a table surface along with a “plus” (“+”) operator block and an “equality” (“=”) operator block to form the equation 5+2=7 (FIG. 12). Once a student has arranged this equation, he can invert the numeral blocks to confirm the equation, the bottom faces 16 showing [5 dots]+[2 dots]=[7 dots].

With further regard to the numeral blocks 10, each numeral block 10 may also include a first side face 20 having a numeral that is the same as the numeral 14 displayed on a corresponding top face 12 (FIG. 1c), although it may be displayed in a smaller font size and oriented such that an equation may be viewed in column format (FIG. 13). A numeral block 10 may be oriented such that the top face 12 and first side face 20 may be visually reviewed simultaneously (FIG. 1a). Similarly, each operator block 30 may include a front face 36 having an operation symbol that is the same as the operation symbol displayed on the top face 32 thereof (FIG. 6b), although it may be displayed in a smaller font size and oriented such that an equation may be viewed in column format (FIG. 13).

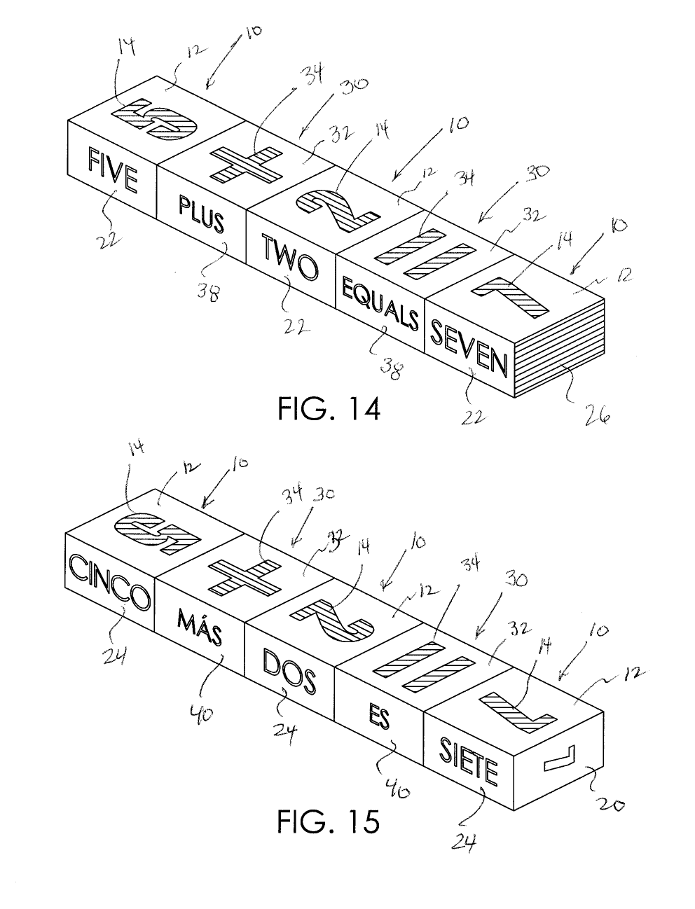

Further, each numeral block 10 may include a second side face 22 having alphabetic text indicative of and normally associated with the numeral 14 on a corresponding top face 12 (FIG. 1a). For instance, if the numeral 14 on an exemplary numeral block 10 is “1,” then the text on a corresponding second side face 22 will be “one.” It is believed that a student's understanding of mathematical concepts is enhanced by numeral blocks 10 showing both a numeral 14 and its associated textual indicator. Similarly, an operator block 30 may also include a rear face 38 having alphabetic text indicative of the operation associated with the operation symbol 34 on the corresponding top face 32 of the respective operator block 30 (FIG. 6a). These features of presenting both a numeral and operator in word form enables an equation to be arranged and read in words rather than symbols (FIG. 14).

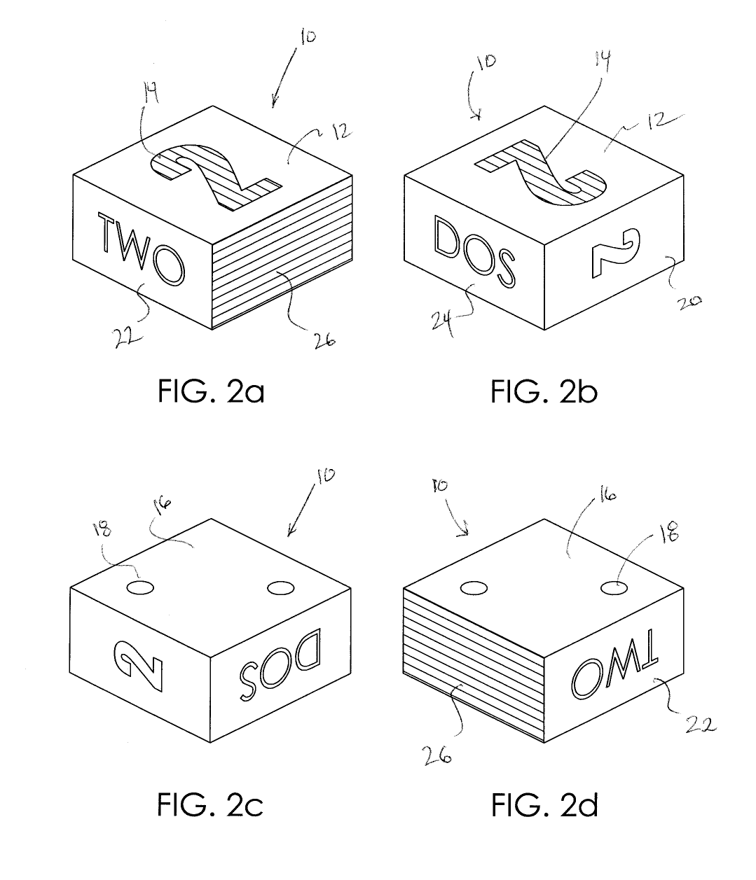

As described thus far, the textual representations of a numeral 14 and an operation symbol 34 have shown them displayed in English. In an embodiment, each numeral block 10 may include a third side face 24 having text corresponding to the numeral 14 on the top face 12 thereof rendered in another language, such as in Spanish. For instance, if the numeral 14 on a top face 12 of a numeral block 10 indicates “2,” then the text on the corresponding third side face 24 will be “dos” (FIG. 2b). Similarly, an exemplary operator block 30 may include a first side face 40 text indicative of the operation symbol 34 on a top face 32 thereof in another language, such as Spanish (FIGS. 6b and 7b). These features enable an equation to be read in words by speakers of a language other than English or by way of training a student to be mathematically bilingual.

Still further, each numeral block 10 may include a fourth side face 26 having first color indicia (for example, a blue color) if the numeral 14 on a corresponding top face 12 is an even number. Or, the fourth side face 26 of a numeral block 10 may include a second color indicia (for example, a red color) if the numeral 14 on a corresponding top face 12 is an odd number. Similarly, the bottom face 16 of respective numeral blocks 10 or simply the dots thereon may include a first color indicia (for example, a blue color) if the numeral 14 on a corresponding top face 12 is a prime number or include a second color indicia (for example, a red color) if the numeral 14 on a corresponding top face 12 is not a prime number.

In an embodiment, one or more of the side faces of a numeral block 10 may include indicia or symbols not previously described, such as the value of the numeral in binary notation, the numeral represented in Braille, or an alphabetic character. In addition, the operator blocks 30 may include other algebraic symbols, multiple variables, parentheses for ordering of operations, blank faces to enable a student to fill in additional equation elements, and the like.

The set of numerical blocks 10 and operator blocks 30 as described above make possible a method for teaching mathematics using equation checking, word and symbol associations, and the concept of “closure.” According to the method, a student or a teacher selects at least two numeral blocks 10 and at least two operator blocks 30. For example, a teacher may select a “5” numeral block 10, a “2” numeral block 10, a “plus” operator block and an “equals” operator block 30. These blocks may then be arranged in the form of an equation: “5+2=”. Then, the student may select a numeral block 10 that results in “closure” of the equation − in this case choosing “7” would correctly close the equation. The equation can be studied and manipulated to help the student in selecting the final numeral block 10. For instance, the equation may be considered by looking at respective text faces, in column format, by considering if the addends are even or odd, or the like.

Once selected, the accuracy of the equation may be checked instantly by inverting the addend and closure numeral blocks 10 to reveal the dot patterns of each, counting the dots, and determining if the dots of the addend blocks equal the number of dots of the closure block. Specifically, adding 5 dots to 2 dots and comparing with the 7 dots of the closure block confirms the correctness of the arranged equation. It is understood, of course, that equations using other standard arithmetic operators may also be used to work with respective types of equations.

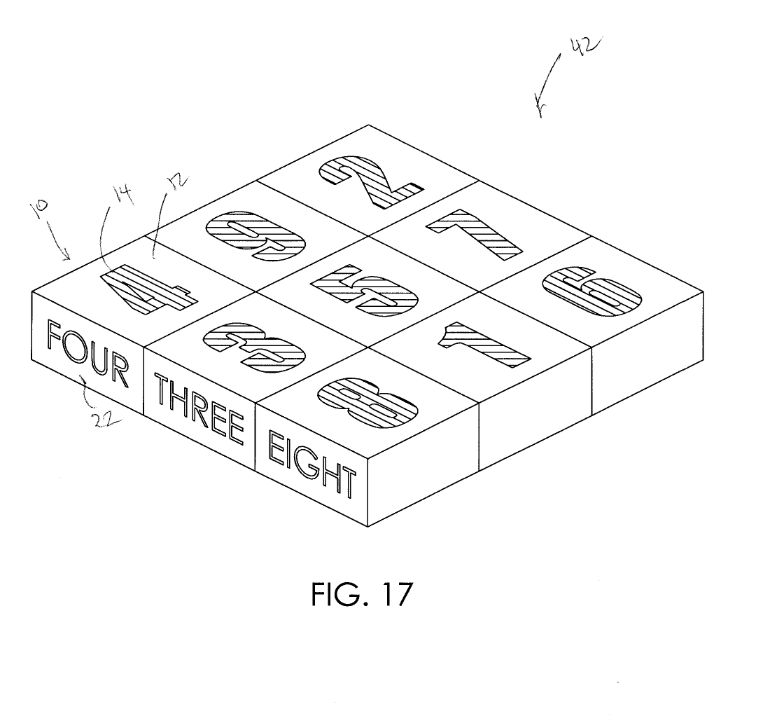

In addition, this method can be used to put together and confirm a magic square 42). A magic square is a 3×3 puzzle-like mathematical representation in which any three contiguous numbers add up to the same number (i.e. lined up as in the game of tic-tac-toe) (FIG. 17). Using the numeral blocks as described above, a proposed magic square 42 can be arranged. Then, by inverting the numeral blocks, the dots of respective dot patterns can be manually added up to confirm if the same number is generated in every group of three contiguous numerals.

In another embodiment, the sets of numeral and operator blocks can be represented in a computer medium, such as computer software, an internet website, a mobile phone app, or the like. Specifically, the set of blocks may be represented on a screen and a user is given opportunity to select numeral blocks 10 and operator blocks 30 (such as by using a mouse or touch screen input means) and arrange them into equations. In the manner described above, the arranged equations can be checked by viewing respective dot patterns of the selected numeral blocks 10.

Beyond being useful for teaching and learning mathematics, the numeral blocks 10 and operator blocks 30 may be used by children for play, such as for building toy houses and buildings.

It is understood that while certain forms of this invention have been illustrated and described, it is not limited thereto except insofar as such limitations are included in the following claims and allowable functional equivalents thereof.

1. A method for teaching mathematics through equation checking, comprising:
providing a plurality of numeral blocks each having a top face that includes a numeral and a bottom face that includes a dot pattern corresponding to the numeral on said top face;
providing a plurality of operator blocks each having a top face that includes an arithmetic operation symbol;
arranging selected numeral blocks and selected operator blocks with respective top faces thereof facing upwardly to form a mathematic equation;
inverting each selected numeral block of the formed mathematical equation such that respective bottom faces are facing upwardly; and
counting respective dot patterns of respective bottom faces so as to check the accuracy of the formed mathematical equation.

2. The method for teaching mathematics as in claim 1, wherein the arranged mathematical equation is one of an addition equation, a subtraction equation, a multiplication equation, or a division equation.

3. The method for teaching mathematics as in claim 1, wherein each numeral block includes a first side face having a numeral that is the same as the numeral on a corresponding top face.

4. The method for teaching mathematics as in claim 5, wherein said each numeral block includes a second side face having text in one language indicative of the numeral on the corresponding top face.

5. The method for teaching mathematics as in claim 6, wherein said each numeral block includes a third side face having text in another language indicative of the numeral on the corresponding top face.

6. The method for teaching mathematics as in claim 7, wherein said each numeral block includes a fourth side having one of a first color indicia indicative that the numeral on the corresponding top face is an even number and a second color indicia indicative that the numeral on the corresponding top face is an odd number.

7. The method for teaching mathematics as in claim 1, wherein said operator block includes:
a front face having an operation symbol that is the same as the operation symbol on said top face thereof;
a rear face opposite said front face having text indicative of the operation symbol on said top face thereof.

8. The method for teaching mathematics as in claim 1, wherein said operation symbol on said top face of a respective operation block is one of an addition symbol, subtraction symbol, multiplication symbol, division symbol, an equals symbol, an inequality symbol, a gozinta symbol, and an algebraic variable symbol.

9. The method for teaching mathematics as in claim 1, comprising the steps of:
arranging selected numeral blocks with respective top faces facing upwardly to form a “magic square” in which an addition operation of any three numbers lined up as in the game of tic-tac-toe equals the same number;
inverting each selected numeral block of the formed magic square such that respective bottom faces are facing upwardly; and
counting respective dot patterns of respective bottom faces so as to check the accuracy of the formed magic square.

10. A set of educational blocks for teaching mathematics, comprising:
a plurality of polygonal-shaped numeral blocks each having a plurality of faces, wherein a top face includes a numeral and a bottom face opposite said top face includes a dot pattern corresponding to the numeral on said top face;
a plurality of polygonal-shaped operator blocks each having a plurality of faces, wherein a top face thereof includes an arithmetic operation symbol;
wherein selected numeral blocks and selected operator blocks are selectively arranged such that respective top faces thereof form an equation and such that the correctness of the arranged equation is determined by revealing respective bottom faces of said selected numeral blocks and counting respective dots thereon.

11. The set of educational blocks as in claim 10, wherein:
each numeral block includes a first side face having the same operation symbol as on said top face thereof; and
each numeral block includes a second side face having text in one language indicative of a name of the same operation symbol on said top face.

12. The set of educational blocks as in claim 11, wherein each numeral block includes a third side face having text in another language indicative of the name of the same operation symbol on said top face.

13. The set of educational blocks as in claim 12, wherein each numeral block includes a fourth side face having one of a first color indicia indicative that the numeral on the corresponding top face is an even number and a second color indicia indicative that the numeral on the corresponding top face is an odd number.

14. The set of educational blocks as in claim 10, wherein said bottom face of a respective numeral block includes one of a first color indicia indicative that the numeral on the corresponding top face is a prime number and a second color indicia indicative that the numeral on the corresponding top face is not a prime number.

15. The set of educational blocks as in claim 10, wherein said operation symbol on said top face of a respective operator block is one of an addition symbol, subtraction symbol, multiplication symbol, division symbol, an equals symbol, an inequality symbol, a gozinta symbol, and an algebraic variable symbol.
